(19) United States
(12) Patent Application Publication
(10) Pub. No.: US 2026/0319342 A1
(43) Pub. Date: Oct. 15, 2026

(54) CAMERA MODULE AND ELECTRONIC DEVICE

(71) Applicant: VIVO MOBILE COMMUNICATION CO., LTD., Dongguan (CN)

(72) Inventors: Feng ZHOU, Dongguan (CN); Qing LIU, Dongguan (CN)

(73) Assignee: VIVO MOBILE COMMUNICATION CO., LTD., Dongguan (CN)

(21) Appl. No.: 19/689,237

(22) Filed: May 27, 2026

Related U.S. Application Data
(63) Continuation of application No. PCT/CN2024/139806, filed on Dec. 17, 2024.

(30) Foreign Application Priority Data
Dec. 21, 2023 (CN) 202311775230.0

(51) Int. Cl. G03B 17/17

(52) U.S. Cl. CPC G03B 17/17

(57) ABSTRACT

This application discloses a camera module and an electronic device, and the disclosed camera module includes a housing, a first lens, a second lens, a photosensitive chip, and a first reflector all arranged in the housing, and the first reflector is able to be switched between a first position and a second position. When the first reflector is in the first position, a light-emitting surface of the first reflector is staggered from the photosensitive chip, and the second lens is opposite to the photosensitive chip, so that light passing through the second lens is projected onto the photosensitive chip; and when the first reflector is in the second position, the light-emitting surface of the first reflector is opposite to the photosensitive chip, so that light passing through the first lens is projected onto the photosensitive chip after being reflected by the first reflector

### CROSS-REFERENCE TO RELATED APPLICATIONS

This application is a continuation application of PCT International Application No. PCT/CN 2024/139806 filed on Dec. 17, 2024, which claims priority to Chinese Patent Application No. 202311775230.0, filed with the China National Intellectual Property Administration on Dec. 21, 2023 and entitled “CAMERA MODULE AND ELECTRONIC DEVICE”, which is incorporated herein by reference in its entirety.

### TECHNICAL FIELD

This application belongs to the field of camera module design technologies, and in particular, to a camera module and an electronic device.

### BACKGROUND

At present, electronic devices (such as mobile phones and tablet computers) are becoming more and more popular in people's daily lives. To meet various shooting requirements, the electronic device is usually equipped with a plurality of camera modules. Configuring a large number of camera modules may lead to high costs of the electronic device, and keep the price of the electronic device high. How to reduce manufacturing costs of the electronic device is an urgent technical problem that manufacturers need to resolve.

### SUMMARY

This application discloses a camera module and an electronic device.

According to a first aspect, this application discloses a camera module, and the disclosed camera module includes a housing, a first lens, a second lens, a photosensitive chip, and a first reflector, where
the first lens, the second lens, the photosensitive chip, and the first reflector are all arranged in the housing, and the first reflector is able to be switched between a first position and a second position;
when the first reflector is in the first position, a light-emitting surface of the first reflector is staggered from the photosensitive chip, and the second lens is opposite to the photosensitive chip, so that light passing through the second lens is projected onto the photosensitive chip; and
when the first reflector is in the second position, the light-emitting surface of the first reflector is opposite to the photosensitive chip, so that light passing through the first lens is projected onto the photosensitive chip after being reflected by the first reflector.

According to a second aspect, this application discloses an electronic device, and the disclosed electronic device includes the camera module described above.

### BRIEF DESCRIPTION OF DRAWINGS

FIG. 1 is a sectional view of a camera module obtained when a first reflector is in a first position according to an embodiment of this application;

FIG. 2 is a schematic diagram of a part of structure of a camera module obtained when a first reflector is in a first position according to an embodiment of this application;

FIG. 3 is a sectional view of a camera module obtained when a first reflector is in a second position according to an embodiment of this application;

FIG. 4 is a schematic diagram of a part of structure of a camera module obtained when a first reflector is in a second position according to an embodiment of this application;

FIG. 5 is a sectional view of a camera module in another structure obtained when a first reflector is in a first position according to an embodiment of this application;

FIG. 6 is a schematic diagram of a part of structure of a camera module according to an embodiment of this application; and

FIG. 7 is a sectional view of a second lens according to an embodiment of this application.

### DESCRIPTION OF REFERENCE NUMERALS

100—Housing, 110—First supporting surface, 111—First guide rail, 120—First light—transmitting opening, 130—Second light-transmitting opening,
200—First lens, 210—Lens element,
300—Second lens, 310—First sub-lens, 320—Second sub-lens, 330—Elastic member, 340—Third driving mechanism, 341—Third electromagnetic coil, 342—Third magnet, 350—Fourth driving mechanism, 351—Fourth electromagnetic coil, 352—Fourth magnet,
400—Photosensitive chip,
500—First reflector, 510—Second guide inclined surface, 511—Second guide rail,
600—Bracket, 610—Light avoidance hole, 620—First guide inclined surface, 630—Second supporting surface,
710—First magnetic member, 720—Second magnetic member,
800—First driving mechanism, 810—First magnet, 820—First electromagnetic coil,
900—Second reflector,
1000—Circuit board,
1110—First rolling element, 1120—Second rolling element, 1130—Third rolling element,
1200—Optical filter.

### DESCRIPTION OF EMBODIMENTS

The terms “first”, “second”, and the like in this specification and claims of this application are used to distinguish between similar objects instead of describing a specific order or sequence. It should be understood that terms used in such a way are interchangeable in proper circumstances, so that embodiments of this application can be implemented in an order other than the order illustrated or described herein. Objects classified by “first”, “second”, and the like are usually of a same type, and a quantity of objects is not limited. For example, there may be one or more first objects. In addition, in this specification and the claims, “and/or” indicates at least one of connected objects, and a character “/” generally indicates an “or” relationship between associated objects.

To make the objectives, technical solutions, and advantages of this application clearer, the following clearly and completely describes the technical solutions of this application with reference to specific embodiments and corresponding accompanying drawings of this application. Apparently, the described embodiments are merely some rather than all of the embodiments of this application.

The technical solutions disclosed in embodiments of this application are described in detail below with reference to the accompanying drawings.

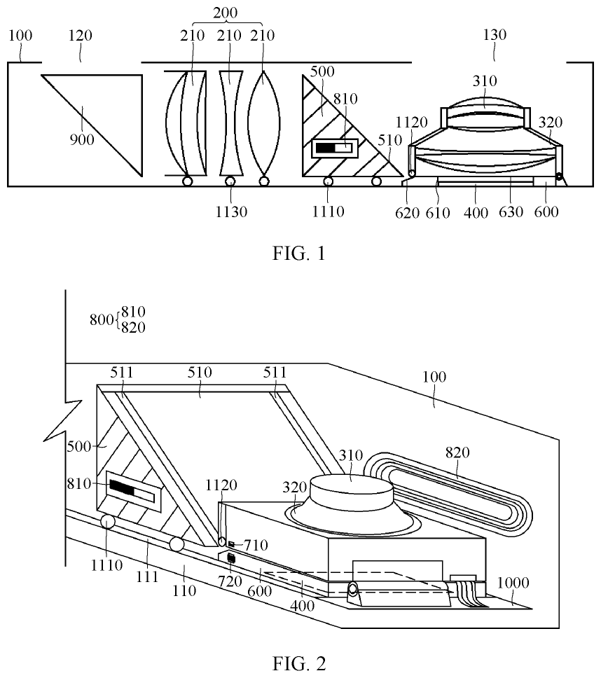

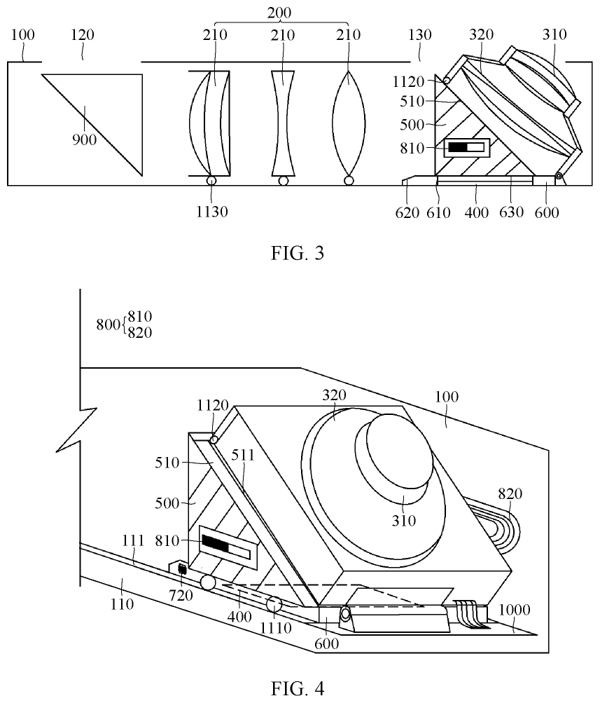

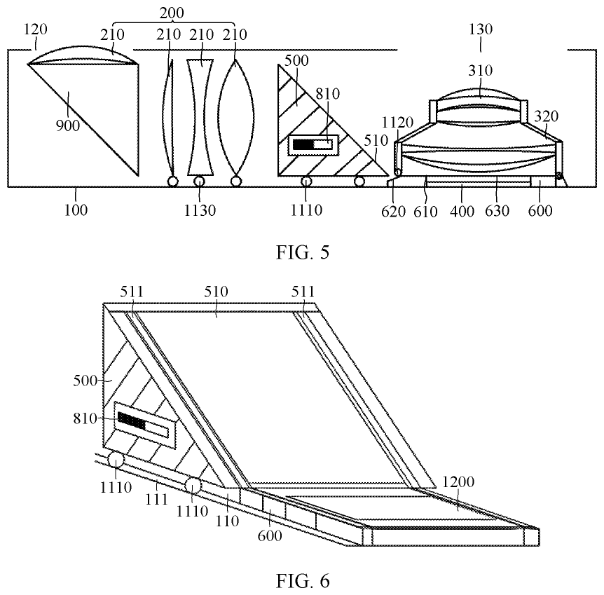

Referring to FIG. 1 to FIG. 7, an embodiment of this application discloses a camera module, and the disclosed camera module includes a housing 100, a first lens 200, a second lens 300, a photosensitive chip 400, and a first reflector 500.

The housing 100 is a basic component of the camera module, and the housing 100 is used to provide installation foundation for other components of the camera module. The first lens 200, the second lens 300, the photosensitive chip 400, and the first reflector 500 are all arranged in the housing 100. In addition, the housing 100 is further used to form some functional spaces or structures, such as a first light-transmitting opening 120 and a second light-transmitting opening 130 described below.

The first lens 200, the second lens 300, and the photosensitive chip 400 are core components that achieve imaging in the camera module, and the first reflector 500 is a core component that enables the first lens 200 and the second lens 300 to share a same photosensitive chip 400. In addition, the first reflector 500 is able to be switched between a first position and a second position, so that the camera module can capture images through the first lens 200 or the second lens 300 respectively by switching a position of the first reflector 500.

In a specific working process, when the first reflector 500 is in the first position, a light-emitting surface of the first reflector 500 is staggered from the photosensitive chip 400, so that the first lens 200 and the photosensitive chip 400 are distributed in a staggered manner, to prevent light exiting from the first lens 200 from being reflected by the first reflector 500 onto a photosensitive surface of the photosensitive chip 400. In addition, the second lens 300 is opposite to the photosensitive chip 400, so that light passing through the second lens 300 is projected onto the photosensitive chip 400. The photosensitive surface of the photosensitive chip 400 receives an optical signal, so that the photosensitive chip 400 converts the optical signal into an electrical signal, thereby achieving imaging. In this case, the camera module captures images through the second lens 300.

When the first reflector 500 is in the second position, the light-emitting surface of the first reflector 500 is opposite to the photosensitive chip 400, and certainly, a light-incident surface of the first reflector 500 may be opposite to the first lens 200, so that light exiting from the first lens 200 is projected onto the photosensitive chip 400 after being reflected by the first reflector 500. The light exiting from the first lens 200 enters the first reflector 500 through the light-incident surface of the first reflector 500, and then exits from the light-emitting surface of the first reflector 500 after being reflected by the first reflector 500, to be projected onto the photosensitive surface of the photosensitive chip 400, that is, the light exiting from the first lens 200 is indirectly projected onto the photosensitive surface of the photosensitive chip 400 through the first reflector 500, and the photosensitive chip 400 is used to convert optical signals into electrical signals, thereby achieving imaging. That is, in this case, the camera module captures images through the first lens 200.

In the camera module disclosed in this embodiment of this application, the first reflector 500 can be set to be switched between the first position and the second position by improving a structure of the camera module involved in the related technology. When the first reflector 500 is in the first position, the light-emitting surface of the first reflector 500 is set to be staggered from the photosensitive chip 400, and the second lens 300 is opposite to the photosensitive chip 400, so that light passing through the second lens 300 is projected onto the photosensitive chip 400, and light exiting from the first lens 200 is prevented from being reflected on the photosensitive surface of the photosensitive chip 400 by the first reflector 500, thereby achieving image capture through the second lens 300. When the first reflector 500 is in the second position, the light-emitting surface of the first reflector 500 is set to be opposite to the photosensitive chip 400, so that light passing through the first lens 200 is projected onto the photosensitive chip 400 after being reflected by the first reflector 500, and light exiting from the second lens 300 is prevented from being projected onto the photosensitive surface of the photosensitive chip 400, thereby achieving image capture through the first lens 200.

In this structure, the photosensitive chip 400 used by the first lens 200 or the second lens 300 for imaging is the same photosensitive chip 400, so that the first lens 200 and the second lens 300 can share the same photosensitive chip 400 for imaging, thereby saving the photosensitive chip 400, and further reducing a number of photosensitive chips 400 in the electronic device equipped with a plurality of camera modules. This is conducive to reducing manufacturing costs of the electronic device. In addition, the photosensitive chip 400 used by the first lens 200 or the second lens 300 for imaging is the same photosensitive chip 400, so that images captured by the first lens 200 or the second lens 300 have the same color, and the image captured when switching from the first lens 200 to the second lens 300 is prevented from shifting laterally.

In addition, in this structure, because the first lens 200 and the second lens 300 are arranged in the same camera module, compared with a case that the first lens 200 and the second lens 300 are respectively arranged in different camera modules, a distance between the first lens 200 and the second lens 300 is shorter. Therefore, a significant shift of the captured image when switching from the first lens 200 to the second lens 300 is reduced, and it is conducive to improving user experience. Meanwhile, both the first lens 200 and the second lens 300 are arranged in the same camera module, which can facilitate installation of the camera module in the electronic device, and can simplify assembly.

In a further technical solution, the first lens 200 and the second lens 300 can be respectively arranged on opposite sides of the first reflector 500, that is, the first reflector 500 is arranged between the first lens 200 and the second lens 300, and the second lens 300 may be rotatably connected to the housing 100, so that a positional relationship between the second lens 300 and the photosensitive chip 400 can be adjusted by rotating the second lens 300.

In a specific working process, when the first reflector 500 is in the first position, the second lens 300 may be overlapped with the photosensitive chip 400, so that the second lens 300 is opposite to the photosensitive surface of the photosensitive chip 400. In this way, the light passing through the second lens 300 is projected onto the photosensitive surface of the photosensitive chip 400, and the photosensitive chip 400 can convert optical signals into electrical signals for imaging, to achieve image capture through the second lens 300.

When the first reflector 500 is in the second position, the second lens 300 may rotate, so that the second lens 300 may be away from the photosensitive surface of the photosensitive chip 400, and the light exiting from the second lens 300 is prevented from being projected onto the photosensitive chip 400. Meanwhile, the light-emitting surface of the first reflector 500 may be opposite to the photosensitive chip 400, and certainly, the light-incident surface of the first reflector 500 may be opposite to the first lens 200, so that the light exiting from the first lens 200 enters the first reflector 500 through the light-incident surface of the first reflector 500, and then exits from the light-emitting surface of the first reflector 500 after being reflected by the first reflector 500, to be projected onto the photosensitive surface of the photosensitive chip 400. The photosensitive chip 400 can convert optical signals into electrical signals for imaging, to achieve image capture through the first lens 200.

In this structure, the second lens 300 is rotated, so that the second lens 300 can be away from or close to the photosensitive surface of the photosensitive chip 400. Therefore, a space required for moving the second lens 300 can be saved, it is conducive to reducing the size of the camera module, and the second lens 300 can be easily reset to the position opposite to the photosensitive chip 400 subsequently.

In an embodiment, a side of the second lens 300 facing away from the first reflector 500 may be rotatably connected to the housing 100, so that a side of the second lens 300 facing the first reflector 500 may rotate around the side of the second lens 300 facing away from the first reflector 500.

In a specific working process, when the first reflector 500 moves from the first position to the second position, the first reflector 500 may be inserted between the second lens 300 and the photosensitive chip 400 to keep the second lens 300 away from the photosensitive surface of the photosensitive chip 400, and the first reflector 500 may push the second lens 300 to rotate, so that the first reflector 500 and the second lens 300 can interact well, avoiding arrangement of an additional driving mechanism to drive the second lens 300 to rotate.

In addition, when the first reflector 500 is in the first position, the side of the second lens 300 facing the first reflector 500 may be close to the photosensitive chip 400, so that the second lens 300 overlaps with the photosensitive chip 400, and the second lens 300 is opposite to the photosensitive surface of the photosensitive chip 400. In this way, the light passing through the second lens 300 can be projected onto the photosensitive surface of the photosensitive chip 400, and the photosensitive chip 400 can convert optical signals into electrical signals for imaging, to achieve image capture through the second lens 300.

When the first reflector 500 is in the second position, the first reflector 500 may be inserted between the second lens 300 and the photosensitive chip 400, and the side of the second lens 300 facing the first reflector 500 may be pushed by the first reflector 500, to rotate away from the photosensitive chip 400. In this way, the second lens 300 is enabled to be away from the photosensitive surface of the photosensitive chip 400, and the light passing through the second lens 300 is prevented from being projected onto the photosensitive chip 400.

Meanwhile, the light-emitting surface of the first reflector 500 may be opposite to the photosensitive chip 400, and the light-incident surface of the first reflector 500 may be opposite to the first lens 200, so that the light exiting from the first lens 200 enters the first reflector 500 through the light-incident surface of the first reflector 500, and then exits from the light-emitting surface of the first reflector 500 after being reflected by the first reflector 500, to be projected onto the photosensitive surface of the photosensitive chip 400. The photosensitive chip 400 can convert optical signals into electrical signals for imaging, to achieve image capture through the first lens 200.

In this structure, the second lens 300 is rotated, so that the second lens 300 can be away from or close to the photosensitive surface of the photosensitive chip 400, and when the first reflector 500 is in the first position, the second lens 300 can be superposed on the first reflector 500, so that a structure between the first reflector 500 and the second lens 300 is more compact. Therefore, the space can be saved, it is conducive to reducing the size of the camera module, and the second lens 300 can be easily reset to the position opposite to the photosensitive chip 400 subsequently.

Certainly, in other embodiments, the second lens 300 may be connected to the first reflector 500, to follow the first reflector 500 to move relative to the housing 100, thereby achieving switching between the first position and the second position. Certainly, this connection mode of the second lens 300 can also achieve the purpose of this embodiment, but in this case, the second lens 300 may not rotate relative to the housing 100, but moves relative to the housing 100 in the housing 100, which is easy to occupy a large space in the housing 100 and is not conducive to miniaturization design of the camera module.

In a feasible technical solution, the camera module may further include a bracket 600, the bracket 600 may be fixed in the housing 100 and covered on the photosensitive chip 400, to protect the photosensitive chip 400 and avoid a situation that the first reflector 500 and the second lens 300 collide or wear the photosensitive chip 400, resulting in failure of the photosensitive chip 400. In addition, the bracket 600 further provides an installation foundation for the second lens 300, to enable the second lens 300 to be placed in an orientation of the photosensitive chip 400.

The second lens 300 may be arranged on the bracket 600, and the side of the second lens 300 facing away from the first reflector 500 may be rotatably connected to the bracket 600, so that the bracket 600 can provide an installation foundation for the second lens 300, and the second lens 300 can be indirectly connected to the housing 100 through the bracket 600. Certainly, the second lens 300 may also be directly connected to the housing 100. Meanwhile, the bracket 600 may be provided with a light avoidance hole 610, the light avoidance hole 610 may be opposite to the photosensitive chip 400, so that the light exiting from the second lens 300 or the light reflected by the first reflector 500 can pass through the light avoidance hole 610 and be projected onto the photosensitive chip 400.

In a specific working process, when the first reflector 500 is in the first position, the side of the second lens 300 close to the first reflector 500 may be supported on the bracket 600, so that the second lens 300 is supported on the bracket 600 and is opposite to the photosensitive chip 400. In this case, the light avoidance hole 610 is opposite to the second lens 300, so that the light passing through the second lens 300 can pass through the light avoidance hole 610 and be projected onto the photosensitive chip 400, and the photosensitive chip 400 converts light signals into electrical signals for imaging, to achieve image capture through the second lens 300.

When the first reflector 500 is in the second position, the side of the second lens 300 close to the first reflector 500 may be away from the bracket 600, and the first reflector 500 may be inserted between the side of the second lens 300 close to the first reflector 500 and the photosensitive chip 400. In this case, the first reflector 500 is located between the bracket 600 and the second lens 300, so that the second lens 300 is away from the photosensitive chip 400, and the light-emitting surface of the first reflector 500 is opposite to the photosensitive surface of the photosensitive chip 400. Certainly, the light-incident surface of the first reflector 500 may be opposite to the first lens 200, and the light-emitting surface of the first reflector 500 may further be opposite to the light avoidance hole 610, so that the light exiting from the first lens 200 can pass through the light avoidance hole 610 after being reflected by the first reflector 500, to be projected onto the photosensitive chip 400. The photosensitive chip 400 can convert optical signals into electrical signals for imaging, to achieve image capture through the first lens 200.

In a further technical solution, the camera module may further include an optical filter 1200, the optical filter 1200 may be provided with a light avoidance hole 610, and may be opposite to the photosensitive chip 400. The photosensitive chip 400 may be located between the optical filter 1200 and the housing 100, so that the light passing through the second lens 300 or the light reflected by the first reflector 500 can pass through the optical filter 1200 and be projected onto the photosensitive chip 400. In this structure, the optical filter 1200 can filter out a part of unnecessary light (for example, red light) among the light reflected by the first reflector 500 to the photosensitive chip 400 or the light projected from the second lens 300 to the photosensitive chip 400, so that a part of light with a specific wavelength that is not required by the camera module and that is reflected by the first reflector 500 or exits from the second lens 300 does not pass through the optical filter 1200, thereby allowing light with other wavelengths that is reflected by the first reflector 500 or passes through the second lens 300 can pass through the optical filter 1200, to be projected onto the photosensitive chip 400 for imaging. This is further conducive to improving imaging quality.

In addition, in this structure, the optical filter 1200 used when the first lens 200 or the second lens 300 images is the same optical filter 1200, so that the first lens 200 and the second lens 300 can share the same optical filter 1200 for imaging, thereby saving the optical filter 1200, and further reducing a number of optical filters 1200 in the electronic device equipped with a plurality of camera modules. This is conducive to further reducing costs of the electronic device.

In an optional technical solution, the camera module may further include a circuit board 1000, the circuit board 1000 may be fixed to the housing 100, the photosensitive chip 400 may be fixed to the circuit board 1000 and may be electrically connected to the circuit board 1000, and the bracket 600 may be fixed to the circuit board 1000 or the housing 100. In this structure, the circuit board 1000 can provide a mounting foundation for the photosensitive chip 400, and can further realize electrical conduction of the photosensitive chip 400, so that the circuit board 1000 can play a dual-purpose role, thereby making full use of the circuit board 1000. In addition, the circuit board 1000 is conducive to simplifying the circuit and avoids the circuit being too complicated due to the use of connecting wires to realize electrical connection. Specifically, the circuit board 1000 may be a printed circuit board or a rigid-flex circuit board, which is not limited in this embodiment of this application.

In a feasible embodiment, the second lens 300 may be provided with a first magnetic member 710, and the bracket 600 may be provided with a second magnetic member 720. When the first reflector 500 is in the first position, the first magnetic member 710 and the second magnetic member 720 may be magnetically attracted to each other, so that a light-emitting surface of the second lens 300 may be opposite to the photosensitive chip 400, and the second lens 300 can be fixed through magnetic attraction fit between the first magnetic member 710 and the second magnetic member 720, so that the second lens 300 can be stably and reliably supported on the bracket 600, and a risk that the second lens 300 is prone to rotation due to external forces and that may affect the imaging quality is reduced.

Optionally, when the first reflector 500 is in the second position, the first magnetic member 710 and the second magnetic member 720 may be magnetically repelled from each other. In this case, the first magnetic member 710 and the second magnetic member 720 repel each other, so that the side of the second lens 300 away from the first reflector 500 can be separated from the bracket 600 more easily, and resistance encountered when the first reflector 500 is inserted between the second lens 300 and the bracket 600 can be reduced, thereby making it easier for the first reflector 500 to move to the second position. Specifically, one of the first magnetic member 710 and the second magnetic member 720 may be an electromagnet, and correspondingly, the other of the first magnetic member 710 and the second magnetic member 720 may be a magnet.

In a further technical solution, one side of the bracket 600 close to the first reflector 500 may have a first guide inclined surface 620, and the bracket 600 may have a second supporting surface 630. The first guide inclined surface 620 may be connected to the second supporting surface 630, to guide the first reflector 500 to move to the second supporting surface 630 through the first guide inclined surface 620, thereby avoiding hindering movement of the first reflector 500.

In the process that the first reflector 500 moves from the first position to the second position, the first reflector 500 moves along the first guide inclined surface 620, to be inserted between the second lens 300 and the bracket 600, to separate the second lens 300 from the photosensitive chip 400, and the first reflector 500 moves, through the first guide inclined surface 620, to the second position above the second supporting surface 630.

Specifically, when the first reflector 500 is in the second position, the first reflector 500 may be supported on the second supporting surface 630. Certainly, the first reflector 500 may also not be supported on the second supporting surface 630, but supported on the first supporting surface 110 as described later, for example, being supported on the first supporting surface 110 through a first rolling element 1110 as described later. In this case, the first reflector 500 may be non-contact with the second supporting surface 630.

In a further technical solution, the housing 100 may have a first supporting surface 110, the first supporting surface 110 may be located below the second supporting surface 630, and the first reflector 500 may be supported above the first supporting surface 110 when the first reflector 500 is in the first position. The first supporting surface 110 may be provided with a first guide rail 111, and the first reflector 500 may be switched between the first position and the second position through the first rolling element 1110 that is in rolling fit with the first guide rail 111.

In this structure, the first reflector 500 is in rolling fit with the first supporting surface 110 through the first rolling element 1110, so that there is a small frictional force between the first reflector 500 and the first supporting surface 110, and the first reflector 500 is able to be switched between the first position and the second position more easily and smoothly. In addition, wear on the first reflector 500 and the first supporting surface 110 can be reduced, and therefore it is conducive to prolonging service life of the first reflector 500 and the first supporting surface 110.

Optionally, the first rolling element 1110 may be partially embedded in the first reflector 500, so that the first rolling element 1110 can be connected to the first reflector 500 in a rolling way, and the first reflector 500 can be guided to move through cooperation between the first rolling element 1110 and the first guide rail 111. The first reflector 500 is prevented from shifting as far as possible that occurs when being switched between the first position and the second position and that may affect the imaging quality.

Certainly, the first reflector 500 may be provided with a second guide inclined surface 510, to guide the side of the second lens 300 facing the first reflector 500 to move on the second guide inclined surface 510, thereby further facilitating the first reflector 500 in moving between the second lens 300 and the bracket 600.

Meanwhile, the second guide inclined surface 510 may be provided with a second guide rail 511, and in the process that the first reflector 500 moves from the first position to the second position, the first reflector 500 may move relative to the second lens 300 through a second rolling element 1120 that cooperates with the second guide rail 511, to push the second lens 300 to rotate. In this structure, the second lens 300 is in rolling fit with the first reflector 500 through the second rolling element 1120, so that there is a small frictional force between the second lens 300 and the first reflector 500. This further facilitates the first reflector 500 in moving between the second lens 300 and the bracket 600, and enables the first reflector 500 to move to the second position more easily and smoothly. In addition, this structure can avoid wear of the second lens 300 and the first reflector 500 as much as possible, thereby being conducive to prolonging service life of the second lens 300 and the first reflector 500.

Optionally, the second rolling element 1120 may be partially embedded in the side of the second lens 300 facing the first reflector 500, so that the second rolling element 1120 is rotatably connected to the second lens 300, and through cooperation between the second guide rail 511 and the second rolling element 1120, the first reflector 500 can be prevented from shifting that occurs during movement and that may affect the imaging quality.

There may be a plurality of first guide rails 111, second guide rails 511, first rolling elements 1110, and second rolling elements 1120. The plurality of first rolling elements 1110 may be in rolling fit with the plurality of first guide rails 111 respectively, and the plurality of second rolling elements 1120 may be in rolling fit with the plurality of second guide rails 511 respectively. Certainly, each of the first guide rails 111 and each of the second guide rails 511 may be in rolling fit with a part of the plurality of first rolling elements 1110 and a part of the plurality of second rolling elements 1120 respectively, so that the fit between the first reflector 500 and the first supporting surface 110 and the fit between the second lens 300 and the first reflector 500 are more stable. Specifically, both the first rolling element 1110 and the second rolling element 1120 may be balls or rollers, which is not limited in this embodiment of this application.

In this embodiment of this application, the first reflector 500 may be a triangular prism, an inclined surface of the triangular prism may be the second guide inclined surface 510, two right-angle surfaces of the triangular prism may be a light-incident surface and a light-emitting surface respectively, the light-incident surface may face the first lens 200, so that light exiting from the first lens 200 can be projected onto the light-incident surface, and the light exiting from the first lens 200 can enter the triangular prism through the light-incident surface.

When the first reflector 500 is in the second position, the light-emitting surface may be opposite to the photosensitive chip 400, so that the light that enters the triangular prism through the light-incident surface can be reflected to the light-emitting surface by the inclined surface of the triangular prism, and can be projected onto the photosensitive chip 400 through the light-emitting surface. The photosensitive chip 400 converts received light signals into electrical signals for imaging.

In a further technical solution, the inclined surface of the triangular prism can be an opaque surface, so that when the first reflector 500 is in the second position, the light exiting from the second lens 300 can be prevented from passing through the inclined surface of the triangular prism and being projected onto the photosensitive chip 400, not to interfere with imaging achieved through the first lens 200.

Certainly, the first reflector 500 may also be a plane reflector arranged obliquely, and a specific structure and type of the first reflector 500 is not limited in this embodiment of this application.

In an optional technical solution, when the first reflector 500 is in the second position, the first reflector 500 may drive the second lens 300 to abut against an inner wall of the housing 100, so that the second lens 300 can be fixed. It is conducive to improving stability of the second lens 300, and can avoid a situation that the second lens 300 is prone to generate abnormal sound due to shaking.

In a feasible technical solution, the camera module may further include a first driving mechanism 800, and the first driving mechanism 800 may be arranged in the housing 100 and may be connected to the first reflector 500 for driving the first reflector 500 to move. The first driving mechanism 800 is used to drive the first reflector 500 to move, so that the first reflector 500 is switched between the first position and the second position. In this structure, the first reflector 500 can be automatically switched between the first position and the second position through the first driving mechanism 800, which is conducive to improving an intelligence and automation degree of the camera module, thereby improving user experience.

In a further technical solution, the first driving mechanism 800 may include a first magnet 810 and a first electromagnetic coil 820, the first electromagnetic coil 820 may be fixed to the housing 100, the first magnet 810 may be fixed to the first reflector 500, and the first electromagnetic coil 820 in an energized state may cooperate with the first magnet 810, to drive the first reflector 500 to move. This structure is simple and easy to realize, which is conducive to reducing the costs of the camera module. Certainly, the first electromagnetic coil 820 may be fixed to the first reflector 500 and move with the first reflector 500, and correspondingly, the first magnet 810 may be fixed to the housing 100. In addition, the first driving mechanism 800 may also be a telescopic driving member, such as an electrostrictive structural member, and a specific type of the first driving mechanism 800 is not limited in this embodiment of this application.

To further prevent the first reflector 500 from shifting when being switched between the first position and the second position, there may be a plurality of first magnets 810 and first electromagnetic coils 820. The plurality of first electromagnetic coils 820 are respectively arranged on two opposite inner walls of the housing 100, and the plurality of first magnets 810 are respectively arranged on opposite sides of the first reflector 500, and each first electromagnetic coil 820 is matched with a corresponding first magnet 810. In this structure, the two opposite sides of the first reflector 500 can be driven by a magnetic force generated by the first electromagnetic coil 820, thereby avoiding a situation that one side of the first reflector 500 is driven by the magnetic force generated by the first electromagnetic coil 820, which is easy to shift. Further, it is conducive to improving driving reliability and stability of the first driving mechanism 800.

Optionally, the first electromagnetic coil 820 may be arranged in the housing 100 and may be opposite to the first magnet 810, to help reduce interference generated when the first electromagnetic coil 820 cooperates with the first magnet 810. Certainly, the first electromagnetic coil 820 is arranged on a relatively stationary housing 100, so that electrical connection of the first electromagnetic coil 820 can be easily realized, and the first electromagnetic coil 820 may not have the problem of the electrical connection being prone to failure due to following the movement of the first reflector 500.

In this embodiment of this application, the housing 100 may be provided with a first light-transmitting opening 120, and incident light may pass through the first light-transmitting opening 120 and enter the first lens 200. The housing 100 may further be provided with a second light-transmitting opening 130, the first light-transmitting opening 120 and the second light-transmitting opening 130 may be arranged at intervals, and incident light may pass through the second light-transmitting opening 130 and enter the second lens 300.

In a specific working process, when the first reflector 500 is in the first position, the incident light can be projected onto the photosensitive chip 400 after passing through the second light-transmitting opening 130 and entering the second lens 300, so that the camera module can capture images through the second lens 300. When the first reflector 500 is in the second position, the incident light can be reflected by the first reflector 500 and projected onto the photosensitive chip 400 after passing through the first light-transmitting opening 120 and entering the first lens 200, so that the camera module can capture images through the first lens 200.

It should be noted that the light passing through the first lens 200 may be the incident light passing through the first light-transmitting opening 120 and entering the first lens 200, and the light passing through the second lens 300 may be the incident light passing through the second light-transmitting opening 130 and entering the second lens 300. In this embodiment of this application, orientations of the first light-transmitting opening 120 and the second light-transmitting opening 130 may be consistent or different.

In a further technical solution, the housing 100 may be provided with a first light-transmitting opening 120, an optical axis direction of the first lens 200 may intersect with an orientation of the first light-transmitting opening 120, for example, the two are perpendicular to each other. The camera module may further include a second reflector 900, and the second reflector 900 may be arranged in the housing 100 and opposite to the first light-transmitting opening 120. The incident light may pass through the first light-transmitting opening 120, the second reflector 900, and the first lens 200, and then exits after being reflected by the first reflector 500.

When the first reflector 500 is in the second position, after passing through the first light-transmitting opening 120 and entering the second reflector 900, the incident light can be reflected by the second reflector 900, and is projected onto the first reflector 500 after passing through the first lens 200, to be reflected by the first reflector 500 onto the photosensitive chip 400, thereby achieving imaging. In this case, the first lens 200 is arranged between the second reflector 900 and the first reflector 500, and the light-incident surface and the light-emitting surface of the second reflector 900 are opposite to the first light-transmitting opening 120 and the first lens 200 respectively, and an optical axis direction of the second lens 300 intersects with the optical axis direction of the first lens 200, for example, being perpendicular to each other.

Furthermore, when the first reflector 500 is in the first position, the optical axis direction of the second lens 300 may be parallel to the orientation of the second light-transmitting opening 130, and the incident light enters the second lens 300 after passing through the second light-transmitting opening 130, and then is projected onto the photosensitive chip 400 after passing through the second lens 300, to achieve imaging. In this case, the orientation of the first light-transmitting opening 120 may be parallel to the orientation of the second light-transmitting opening 130. This structure enables the first lens 200, the first light-transmitting opening 120, and the second reflector 900 to form a periscope lens, thereby avoiding occupying a size of the orientation of the first light-transmitting opening 120 (usually a thickness direction of the electronic device), which is conducive to thinning of the electronic device. The periscope lens is conducive to telephoto shooting of the camera module.

In this embodiment of this application, the second reflector 900 may be a triangular prism or a plane reflector. Similarly, a specific structure of the second reflector 900 is not limited in this embodiment of this application.

Certainly, the orientation of the first light-transmitting opening 120 may be parallel to the optical axis direction of the first lens 200, and the first light-transmitting opening 120 may be opposite to the first lens 200. Light passing through the first light-transmitting opening 120 may directly pass through the first lens 200 and is projected onto the first reflector 500, to be reflected by the first reflector 500 onto the photosensitive chip 400, thereby achieving imaging. In this case, the orientation of the first light-transmitting opening 120 may be perpendicular to the orientation of the second light-transmitting opening 130.

In a further technical solution, the first lens 200 may include a plurality of lens elements 210, and the plurality of lens elements 210 may be movably arranged in the housing 100. Specifically, in the process that the first reflector 500 moves from the second position to the first position, at least one of the plurality of lens elements 210 may move in a direction away from the second lens 300, so that the plurality of lens elements 210 converge in a moving direction of the first reflector 500. Therefore, when the first reflector 500 is in the first position, there is a small gap among the plurality of lens elements 210.

As described above, in the process that the first reflector 500 moves from the second position to the first position, a lens element 210 farthest from the first reflector 500 among the plurality of lens elements 210 may be kept still, and other lens elements 210 in the plurality of lens elements 210 may move in the direction away from the second lens 300, so that the plurality of lens elements 210 converge in the moving direction of the first reflector 500. Certainly, a lens element 210 nearest from the first reflector 500 among the plurality of lens elements 210 may alternatively move in the direction away from the second lens 300, and other lens elements 210 among the plurality of lens elements 210 may be kept still, so that the plurality of lens elements 210 converge in the moving direction of the first reflector 500.

In this structure, the structure of the first lens 200 is more compact, so that a shaking amplitude of the plurality of lens elements 210 when impacted by external force can be reduced. Further, it is conducive to reducing abnormal sound generated by shaking of the plurality of lens elements 210, and the first lens 200 occupies a small space.

In the process that the first reflector 500 moves from the first position to the second position, at least one of the plurality of lens elements 210 may move in a direction close to the second lens 300, so that the plurality of lens elements 210 are scattered in the moving direction of the first reflector 500. Therefore, the plurality of lens elements 210 can move to a preset position, to ensure the imaging quality.

Specifically, in the process that the first reflector 500 moves from the first position to the second position, the lens element 210 farthest from the first reflector 500 among the plurality of lens elements 210 may be kept still, and other lens elements 210 in the plurality of lens elements 210 may move in the direction close to the second lens 300, so that the plurality of lens elements 210 are scattered in the moving direction of the first reflector 500. Certainly, the plurality of lens elements 210 may alternatively move in the direction close to the second lens 300, and the plurality of lens elements 210 are scattered in the moving direction of the first reflector 500.

In this structure, the plurality of lens elements 210 are converged when the first reflector 500 is in the first position, so that the space required by the first reflector 500 is saved, and the space in the camera module can be fully utilized to avoid increasing the size of the camera module. In addition, the plurality of lens elements 210 are scattered when the first reflector 500 is in the second position, so that the first lens 200 can be ensured to shoot normally, and the plurality of lens elements 210 can be prevented from occupying a large space, to avoid increasing the size of the camera module. Further, it is conducive to reducing the space of the electronic device occupied by the camera module and facilitating a layout in the electronic device.

To further save space, a part of the lens elements 210 may be arranged on the second reflector 900 and opposite to the first light-transmitting opening 120, that is, a part of the lens elements 210 is arranged on a side of the second reflector 900 facing the first light-transmitting opening 120, so that light passing through the first light-transmitting opening 120 may enter the second reflector 900 after passing through the part of the lens elements 210, and then is reflected by the second reflector 900 and is projected onto the first reflector 500 after passing through another part of the lens elements 210 (that is, a lens element 210 arranged between the first reflector 500 and the second reflector 900), to be reflected by the first reflector 500 onto the photosensitive chip 400, thereby achieving imaging. In this structure, because a part of the lens elements 210 is arranged on the side of the second reflector 900 facing the first light-transmitting opening 120, a space between the second reflector 900 and the first reflector 500 can be saved, which is conducive to further reducing the size of the camera module, further reducing the space of the electronic device occupied by the camera module, and facilitating the layout in the electronic device.

Certainly, the camera module may further include a second driving mechanism, the second driving mechanism may include a plurality of second electromagnetic coils and a plurality of second magnets. The plurality of second electromagnetic coils may be fixed to the housing 100, and the plurality of second magnets may be fixed to the plurality of lens elements 210 respectively. The plurality of energized second electromagnetic coils may cooperate with the plurality of second magnets, to drive the plurality of lens elements 210 to move, so that the plurality of lens elements 210 can be automatically adjusted, thereby achieving automatic focusing of the first lens 200, and being conducive to further enhancing shooting experience of the user.

In a further technical solution, the first lens 200 may further include a lens barrel, and a part of the housing 100 may be used as the lens barrel. In this structure, the housing 100 can play a dual-purpose role, to avoid setting an additional lens barrel for the first lens 200, thereby saving a space occupied by the lens barrel of the first lens 200, and being conducive to further reducing the size of the camera module. Optionally, the plurality of lens elements 210 may be in rolling fit with the lens barrel through a plurality of third rolling elements 1130 respectively, to facilitate adjustment of the lens element, and enable movement of the lens element to be smoother. Certainly, the third rolling element 1130 may be a ball or a roller, which is not limited in this embodiment of this application.

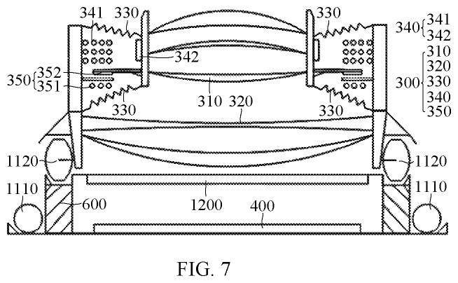

In this embodiment of this application, as shown in FIG. 7, the second lens 300 may include a first sub-lens 310, a second sub-lens 320, an elastic member 330, a third driving mechanism 340, and a fourth driving mechanism 350. A side of the second sub-lens 320 away from the first reflector 500 may be rotatably connected to the bracket 600, and the first sub-lens 310 may be connected to an end of the second sub-lens 320 away from the bracket 600 through the elastic member 330, so that the first sub-lens 310 can move relative to the second sub-lens 320.

Specifically, when the first reflector 500 is in the first position, a side of the second sub-lens 320 close to the first reflector 500 may be supported on the bracket 600, and light passing through the second light-transmitting opening 130 may pass through the first sub-lens 310 and the second sub-lens 320 in turn, to be projected onto the photosensitive chip 400, thereby achieving imaging. When the first reflector 500 is in the second position, the side of the second sub-lens 320 close to the first reflector 500 may be separated from the bracket 600, and may drive the first sub-lens 310 to be away from the photosensitive chip 400 together.

Further, continue to refer to FIG. 7. The third driving mechanism 340 may include a third electromagnetic coil 341 and a third magnet 342, the fourth driving mechanism 350 may include a fourth electromagnetic coil 351 and a fourth magnet 352, the third electromagnetic coil 341 and the fourth electromagnetic coil 351 may be separately fixed to the second sub-lens 320, and the third magnet 342 and the fourth magnet 352 may be separately fixed to the first sub-lens 310. Both the third electromagnetic coil 341 and the fourth electromagnetic coil 351 may be arranged around the first sub-lens 310, and the two may not interfere with each other. The third electromagnetic coil 341 may drive, through the third magnet 342, the first sub-lens 310 to perform focusing movement, to achieve automatic focusing of the second lens 300, and the fourth electromagnetic coil 351 may drive, through the fourth magnet 352, the first sub-lens 310 to perform anti-shake movement, to achieve automatic anti-shake of the second lens 300. This is conducive to further improving user experience.

In an optional technical solution, there may be a plurality of elastic members 330, so that reliability and stability of connection between the first sub-lens 310 and the second sub-lens 320 can be improved. In addition, there may be a plurality of third magnets 342 matched with the third electromagnetic coil 341 and a plurality of fourth magnets 352 matched with the fourth electromagnetic coil 351, so that it is easier for the third electromagnetic coil 341 and the fourth electromagnetic coil 351 to drive the first sub-lens 310 to move through the plurality of third magnets 342 and the plurality of fourth magnets 352 respectively, and driving efficiency of the third driving mechanism 340 and the fourth driving mechanism 350 can be further improved. Specifically, the elastic member 330 may be a spring or rubber, which is not limited in this embodiment of this application.

Based on the camera module disclosed in the embodiments of this application, this application further discloses an electronic device. The disclosed electronic device includes the camera module in any one of the foregoing embodiments.

In the embodiments of this application, the electronic device may be a mobile phone, a tablet computer, a notebook computer, or a smart wearable device. This is not limited in the embodiments of this application.

The foregoing embodiments of this application focus on describing differences between the embodiments, and different optimization features of the embodiments may be combined to form better embodiments provided that they are not contradictory. For brevity, details are not described herein again.

The embodiments of this application are described above with reference to the accompanying drawings, but this application is not limited to the foregoing specific implementations, and the foregoing specific implementations are only illustrative and not restrictive.

1. A camera module, comprising a housing, a first lens, a second lens, a photosensitive chip, and a first reflector, wherein
the first lens, the second lens, the photosensitive chip, and the first reflector are all arranged in the housing, and the first reflector is able to be switched between a first position and a second position;
when the first reflector is in the first position, a light-emitting surface of the first reflector is staggered from the photosensitive chip, and the second lens is opposite to the photosensitive chip, so that light passing through the second lens is projected onto the photosensitive chip; and
when the first reflector is in the second position, the light-emitting surface of the first reflector is opposite to the photosensitive chip, so that light passing through the first lens is projected onto the photosensitive chip after being reflected by the first reflector.

2. The camera module according to claim 1, wherein the first lens and the second lens are respectively arranged on opposite sides of the first reflector, and the second lens is rotatably connected to the housing;
when the first reflector is in the first position, the second lens overlaps with the photosensitive chip; and
when the first reflector is in the second position, the second lens is rotated, so that the second lens moves away from a photosensitive surface of the photosensitive chip, and the light-emitting surface of the first reflector is opposite to the photosensitive chip.

3. The camera module according to claim 1, wherein a side of the second lens facing away from the first reflector is rotatably connected to the housing; and
in a process that the first reflector moves from the first position to the second position, the first reflector is inserted between the second lens and the photosensitive chip, and the first reflector pushes the second lens to rotate.

4. The camera module according to claim 2, wherein the camera module further comprises a bracket, the bracket is fixed in the housing and covered on the photosensitive chip, the bracket is provided with a light avoidance hole, the second lens is arranged on the bracket, and a side of the second lens opposite to the first reflector is rotatably connected to the bracket;
when the first reflector is in the first position, a side of the second lens close to the first reflector is supported on the bracket; and
when the first reflector is in the second position, the side of the second lens close to the first reflector is away from the bracket and the first reflector is inserted between the side of the second lens close to the first reflector and the photosensitive chip.

5. The camera module according to claim 4, wherein the second lens is provided with a first magnetic member, and the bracket is provided with a second magnetic member, wherein when the first reflector is in the first position, the first magnetic member and the second magnetic member are magnetically attracted to each other, so that a light-emitting surface of the second lens is opposite to the photosensitive chip.

6. The camera module according to claim 5, wherein when the first reflector is in the second position, the first magnetic member and the second magnetic member are magnetically repelled from each other.

7. The camera module according to claim 4, wherein a side of the bracket close to the first reflector has a first guide inclined surface, the bracket has a second supporting surface, and the first guide inclined surface is connected to the second supporting surface; and
in the process that the first reflector moves from the first position to the second position, the first reflector moves along the first guide inclined surface to separate the second lens from the photosensitive chip, and the first reflector moves, through the first guide inclined surface, to the second position above the second supporting surface.

8. The camera module according to claim 7, wherein the housing has a first supporting surface, the first supporting surface is located below the second supporting surface, the first supporting surface is provided with a first guide rail, and the first reflector is switched between the first position and the second position through a first rolling element that is in rolling fit with the first guide rail.

9. The camera module according to claim 2, wherein the first reflector is provided with a second guide inclined surface, the second guide inclined surface is provided with a second guide rail, and in the process that the first reflector moves from the first position to the second position, the first reflector moves relative to the second lens through a second rolling element that cooperates with the second guide rail, to push the second lens to rotate.

10. The camera module according to claim 9, wherein the first reflector is a triangular prism, an inclined surface of the triangular prism is the second guide inclined surface, two right-angle surfaces of the triangular prism are a light-incident surface and a light-emitting surface respectively, the light-incident surface faces the first lens, and when the first reflector is in the second position, the light-emitting surface is opposite to the photosensitive chip.

11. The camera module according to claim 10, wherein the inclined surface of the triangular prism is an opaque surface.

12. The camera module according to claim 1, wherein the camera module further comprises a first driving mechanism, the first driving mechanism is arranged in the housing and connected to the first reflector for driving the first reflector to move, so that the first reflector is switched between the first position and the second position.

13. The camera module according to claim 12, wherein the first driving mechanism comprises a first magnet and a first electromagnetic coil, the first electromagnetic coil is fixed to the housing, the first magnet is fixed to the first reflector, and the first electromagnetic coil in an energized state cooperates with the first magnet, to drive the first reflector to move.

14. The camera module according to claim 1, wherein the housing is provided with a first light-transmitting opening, and incident light passes through the first light-transmitting opening and enters the first lens; and
the housing is further provided with a second light-transmitting opening, the first light-transmitting opening and the second light-transmitting opening are arranged at intervals, and incident light passes through the second light-transmitting opening and enters the second lens.

15. The camera module according to claim 1, wherein the housing is provided with a first light-transmitting opening, the camera module further comprises a second reflector, the second reflector is arranged in the housing and is opposite to the first light-transmitting opening, and after passing through the first light-transmitting opening, the second reflector, and the first lens, incident light is reflected by the first reflector and exits.

16. The camera module according to claim 1, wherein the first lens comprises a plurality of lens elements, and the plurality of lens elements are movably arranged in the housing, wherein:
in a process that the first reflector moves from the second position to the first position, at least one of the plurality of lens elements moves in a direction away from the second lens, so that the plurality of lens elements converge in a moving direction of the first reflector; and
in a process that the first reflector moves from the first position to the second position, at least one of the plurality of lens elements moves in a direction close to the second lens, so that the plurality of lens elements are scattered in the moving direction of the first reflector.

17. The camera module according to claim 1, wherein the first lens further comprises a lens barrel, and a part of the housing serves as the lens barrel.

18. An electronic device, comprising a camera module, wherein the camera module comprises a housing, a first lens, a second lens, a photosensitive chip, and a first reflector, wherein
the first lens, the second lens, the photosensitive chip, and the first reflector are all arranged in the housing, and the first reflector is able to be switched between a first position and a second position;
when the first reflector is in the first position, a light-emitting surface of the first reflector is staggered from the photosensitive chip, and the second lens is opposite to the photosensitive chip, so that light passing through the second lens is projected onto the photosensitive chip; and
when the first reflector is in the second position, the light-emitting surface of the first reflector is opposite to the photosensitive chip, so that light passing through the first lens is projected onto the photosensitive chip after being reflected by the first reflector.

19. The electronic device according to claim 18, wherein the first lens and the second lens are respectively arranged on opposite sides of the first reflector, and the second lens is rotatably connected to the housing;
when the first reflector is in the first position, the second lens overlaps with the photosensitive chip; and
when the first reflector is in the second position, the second lens is rotated, so that the second lens moves away from a photosensitive surface of the photosensitive chip, and the light-emitting surface of the first reflector is opposite to the photosensitive chip.

20. The electronic device according to claim 18, wherein a side of the second lens facing away from the first reflector is rotatably connected to the housing; and
in a process that the first reflector moves from the first position to the second position, the first reflector is inserted between the second lens and the photosensitive chip, and the first reflector pushes the second lens to rotate.
